(19) United States
(12) Patent Application Publication
(10) Pub. No.: US 2012/0147023 A1
(43) Pub. Date: Jun. 14, 2012

(54) CACHING APPARATUS AND METHOD FOR VIDEO MOTION ESTIMATION AND COMPENSATION

(75) Inventors: Seunghyun CHO, Daejeon (KR); Nak Woong Eum, Daejeon (KR); Seong Mo Park, Daejeon (KR); Hee-Bum Jung, Daejeon (KR)

(73) Assignee: ELECTRONICS AND TELECOMMUNICATIONS RESEARCH INSTITUTE, Daejeon (KR)

(21) Appl. No.: 13/297,290

(22) Filed: Nov. 16, 2011

(30) Foreign Application Priority Data
Dec. 14, 2010 (KR) 10-2010-0127574

(51) Int. Cl. G09G 5/36

(52) U.S. Cl. 345/557

(57) ABSTRACT

A caching apparatus for video motion estimation and compensation includes: an external memory including a plurality of banks and configured to allocate one pixel row to one bank to store the pixel row; a memory controller configured to cause successively-inputted read requests to access different banks of the external memory and transmit a read command for a next read request to the external memory while reference data corresponding to a first-coming read request is outputted; and a data processor configured to successively make read requests for the reference data to the memory controller when reference data read requests are successively inputted, store the reference data inputted from the memory controller, and output the stored reference data.

### CROSS-REFERENCES TO RELATED APPLICATIONS

The present application claims priority under 35 U.S.C 119(a) to Korean Application No. 10-2010-0127574, filed on Dec. 14, 2010 in the Korean intellectual property Office, which is incorporated herein by reference in its entirety set forth in full.

### BACKGROUND

Exemplary embodiments of the present invention relate to control technology for effectively utilizing a cache in order for motion estimation for compressing video data or motion compensation for decompressing the compressed video data, and more particularly, to a caching apparatus and method for video motion estimation and compensation, which transmits a read command for a next request to an external memory while reference data stored in the external memory is outputted, and performs an overlapped read operation.

Generally, in a video format such as MPEG2, MPEG4, or H.264/AVC, one image frame is divided into a plurality of blocks, and compression and decompression are performed by the unit of block. Furthermore, motion estimation for acquiring a high compression gain by removing temporal redundancy of an image is widely used.

The motion estimation includes a process of acquiring a motion vector by estimating a motion from a frame encoded before a current block which is to be compressed.

During this process, an operation of reading a predetermined region of a reference frame and determining a similarity to the current block is repetitively performed to find a motion vector which may obtain high compression efficiency. Such an operation is performed on one or more reference frames.

In the case of a typical system, an encoded frame is stored in a high-capacity external memory such as SDRAM through a memory bus. Therefore, the motion estimation requires a high memory bandwidth.

Meanwhile, the motion compensation includes a process of acquiring an estimation signal from a reference frame by using motion vector information of a block which is to be decompressed. A predetermined region of the reference frame indicated by the motion vector should be read to acquire the estimation signal, and one block may have a plurality of motion vectors and reference frames, if necessary. Therefore, the motion compensation also requires a high memory bandwidth.

The above-described configuration is a related art for helping an understanding of the present invention, and does not mean a related art which is widely known in the technical field to which the present invention pertains.

Conventionally, frequent accesses to an external memory, which occur during the motion estimation and compensation process, have caused such a problem that a memory bandwidth secured by the system excessively increases, and increased power consumption to reduce the lifetime of a battery in the case of a mobile device. In particular, as the resolution of a screen increases, such a problem becomes more severe.

Therefore, methods for sharing reference data used in one block or between adjacent blocks by adopting a cache for motion estimation or motion compensation have been proposed, in order to reduce the number of external memory requests.

However, in the case of SDRAM which is generally as an external memory in a video system, a considerable delay time is required until requested data is obtained, due to a characteristic of the device. Therefore, although the cache is used to reduce the number of external memory requests, a substantial memory bandwidth considering a delay time required for reading SDRAM to compress and decompress high-resolution video data such as high definition (HD) data is still high.

### SUMMARY

An embodiment of the present invention relates to a caching apparatus and method for video motion estimation and compensation, which transmits a read command for a next request to an external memory while reference data stored in the external memory is outputted, and performs an overlapped read operation, thereby reducing a time required for reading reference data from the external memory.

In one embodiment, a caching apparatus for video motion estimation and compensation includes: an external memory comprising a plurality of banks and configured to allocate one pixel row to one bank to store the pixel row; a memory controller configured to cause different banks of the external memory to be accessed according to successively-inputted read requests and to transmit a read command for a next read request to the external memory while reference data corresponding to a first-coming read request is outputted; and a data processor configured to successively make read requests for the reference data to the memory controller when reference data read requests are successively inputted, store the reference data inputted from the memory controller, and output the stored reference data.

An external memory address of the reference data stored in the external memory may be generated in such a manner that the least significant bit of a Y position value of the reference data is allocated to a bank value of the external memory address.

The data processor may include: a cache configured to store and output the reference data; an internal memory address processing unit configured to generate an internal memory address for outputting the reference data and output the generated internal memory address; an external memory address processing unit configured to generate an external memory address of the reference data to make a read request to the memory controller through the external memory address, and store the reference data inputted from the memory controller in the cache; and a tag index processing unit configured to generate a tag and index for cache reference and output the reference data stored in the cache when a cache hit occur. At a cache reference step, when a cache hit occurs, the internal memory address and the tag and index are outputted, and at a cache update step, the reference data and the internal memory address are outputted according to a cache miss occurring at the cache reference step.

The cache update step may be performed after the cache reference step according to successive read requests is completely performed.

When a cache miss occurs during the cache reference step according to successive read requests, the cache update step may be performed immediately after the cache miss.

The external memory address processing unit may include: an external memory address generation section configured to generate an external memory address of the reference data for outputting the reference data; an external memory address storage section configured to store the external memory address generated by the external memory address generation section; a reference data input and output section configured to read the external memory address stored in the external memory address storage section and request the memory controller to read the reference data stored in the external memory; and a reference data storage section configured to store the reference data inputted from the reference data input and output section and then store the reference data in the cache.

The internal memory address processing unit may include: an internal memory address generation section configured to generate an internal memory address from an address of the reference data; and an internal memory address storage section configured to store the internal memory address generated by the internal memory address generation section when a cache miss occurs.

The tag and index processing unit may include: a tag index generation section configured to generate the tag and index from an address of the reference data; and a tag index storage section configured to store the tag and index generated by the tag index generation section when a cache miss occurs.

In another embodiment, a caching method for video motion estimation and compensation includes: allocating one pixel row of a reference frame to one bank to store the pixel row; and when read requests are successively inputted due to a cache miss, accessing different banks of the external memory, and transmitting a read command for a next read request to the external memory while reference data corresponding to a first-coming read request is read and outputted.

The external memory address of the reference data may be generated in such a manner that the least significant bit of a Y position value of the reference data is allocated to a bank value of the external memory address.

In another embodiment, a caching method for video motion estimation and compensation includes: allocating one pixel row of a reference frame to one bank to store the pixel row; performing a cache reference step as reference data are successively requested;

and when a cache miss occurs during the cache reference step, reading the reference data by accessing different banks of an external memory according to the read requests of the reference data and performing a cache update step.

The performing of the cache update step may include transmitting a read command for a next read request to the external memory while the reference data is read from the external memory and outputted.

The cache update step may be performed after the cache reference step is completely performed.

The cache update step may be performed immediately after the cache miss occurs while the cache reference step is performed.

An external memory address of the reference data may be generated in such a manner that the least significant bit of a Y position value of the reference data is allocated to a bank value of the external memory address.

### BRIEF DESCRIPTION OF THE DRAWINGS

The above and other aspects, features and other advantages will be more clearly understood from the following detailed description taken in conjunction with the accompanying drawings, in which:

FIG. 1 is a block diagram of a caching apparatus for video motion estimation and compensation in accordance with an embodiment of the present invention;

FIG. 2 is a timing diagram showing an example of an overlapped read operation of an external memory in accordance with the embodiment of the present invention;

FIG. 3 is a diagram showing an example in which pixel row numbers and bank numbers are allocated when a reference frame is stored in an external memory having a plurality of banks in accordance with the embodiment of the present invention;

FIG. 4 is a diagram showing an address for reading reference data from the external memory in accordance with the embodiment of the present invention;

FIG. 5 is a block diagram of a data processor in accordance with the embodiment of the present invention; and

FIG. 6 is a diagram showing a request method and order of reference data in accordance with the embodiment of the present invention.

### DESCRIPTION OF SPECIFIC EMBODIMENTS

Hereinafter, a caching apparatus and method for video motion estimation and compensation in accordance with embodiments of the present invention will be described with reference to accompanying drawings. The drawings are not necessarily to scale and in some instances, proportions may have been exaggerated in order to clearly illustrate features of the embodiments. Furthermore, terms to be described below have been defined by considering functions in embodiments of the present invention, and may be defined differently depending on a user or operator's intention or practice. Therefore, the definitions of such terms are based on the descriptions of the entire present specification.

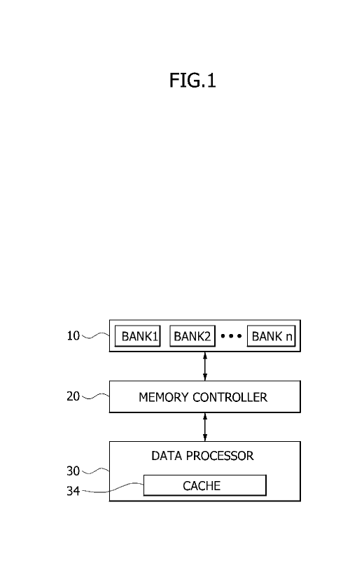

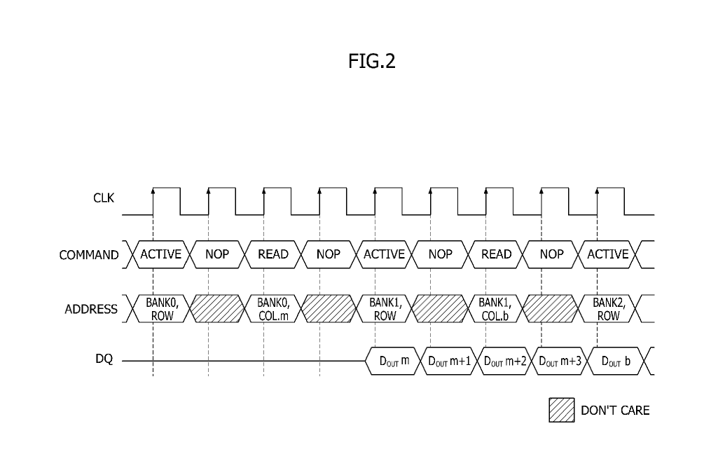

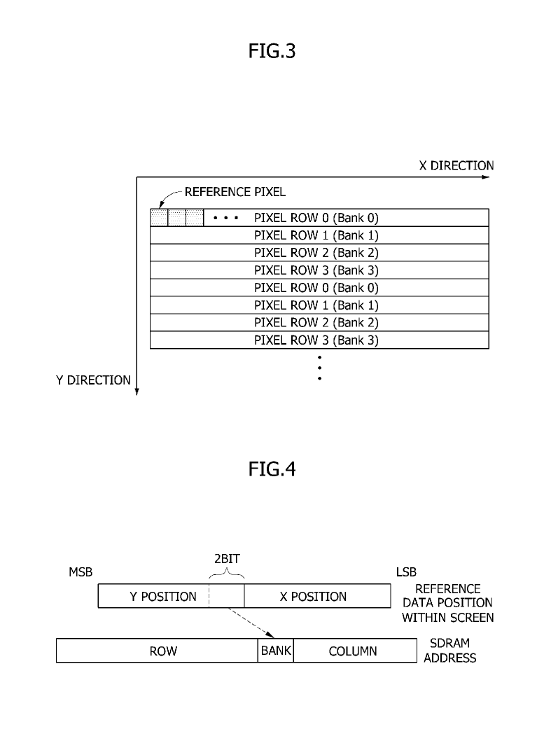

FIG. 1 is a block diagram of a caching apparatus for video motion estimation and compensation in accordance with an embodiment of the present invention. FIG. 2 is a timing diagram showing an example of an overlapped read operation of an external memory in accordance with the embodiment of the present invention. FIG. 3 is a diagram showing an example in which pixel row numbers and bank numbers are allocated when a reference frame is stored in an external memory having a plurality of banks in accordance with the embodiment of the present invention.

The caching apparatus for video motion estimation and compensation in accordance with the embodiment of the present invention includes an external memory 10 such as SDRAM, a memory controller 20, and a data processor 30.

The external memory 10 includes a plurality of banks, and a reference frame is stored in the external memory 10 having a plurality of banks. The external memory 10 may be accessed through the memory controller 20 having one or more read ports.

The memory controller 20 provides an interface between the external memory 10 and the data processor 30, and is configured to read reference data stored in the external memory 10 according to a read request of the data processor 30 for the reference data.

The data processor 30 includes a cache 34 to store reference data for a partial region of the reference frame and is configured to output the reference data stored in the cache 34 according to read requests for the reference data, which are successively inputted.

When a cache miss occurs during this process, a read request for the reference data is made to the memory controller 20, and the reference data inputted from the memory controller 20 is stored in the cache 34 and then outputted.

That is, the data processor 30 brings reference data of a necessary reference region through the cache 34 in which a partial region of the reference frame is stored.

In this case, when the memory controller 20 reads data from the external memory 10, the memory controller 20 causes successive read requests to access different banks of the external memory 10 and transmits a read command for a next read request to the external memory 10 while reference data corresponding to a first-coming read request is outputted from the external memory 10. Therefore, the overlapped read operation may be performed.

FIG. 2 shows an example of the overlapped read operation of the external memory 10 when a burst length is set to 4, a first read request accesses a zero-th bank, and a second read request accesses a first bank.

When read requests are sequentially made to bring necessary reference data from the external memory 10, the data processor 30 causes the successive read requests to access different banks through the overlapped read operation of the external memory 10.

For this operation, when the memory banks are allocated to store the reference frame in the external memory 10, one pixel row of the reference frame is stored in one bank. The pixel row includes a plurality of pixels which are successive in the left and right direction of the reference frame.

The next pixel row is stored in a different bank, and pixel rows adjacent in the upper and lower sides are stored to exist in different memory banks.

Each memory bank has a pixel row number and a bank number which are allocated thereto. FIG. 3 shows an example in which pixel row numbers and bank numbers are allocated when the reference frame is stored in the external memory 10 having 0-th to third banks.

Referring to FIG. 3, it can be seen that each of the pixel rows is stored in one memory bank, and the pixel row numbers (pixel row 0 to pixel row 3) and the bank numbers (Bank 0 to Bank 3) are allocated.

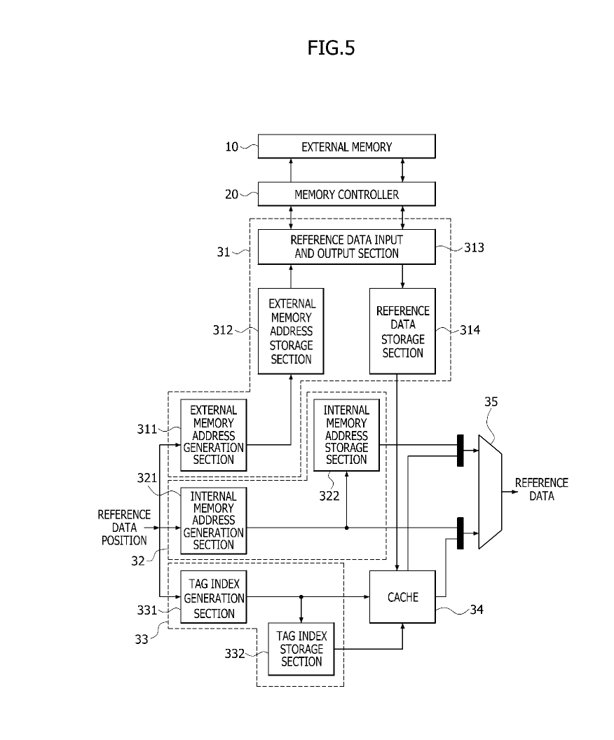

Accordingly, referring to FIG. 4, an external memory address for reading reference data from the external memory 10 is generated in such a manner that two least significant bits of the Y position of the reference data within the screen are allocated to a bank value of the external memory address.

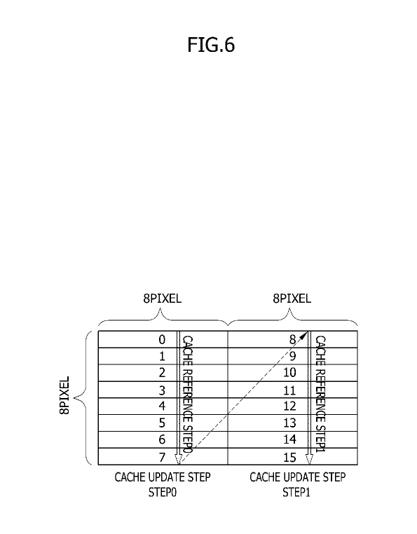

FIG. 5 is a block diagram of a data processor in accordance with the embodiment of the present invention. FIG. 6 is a diagram showing a request method and order of reference data in accordance with the embodiment of the present invention.

The data processor 30 serves to acquire necessary reference data through the cache 34 by utilizing an overlapped read operation for the external memory 10. When reference data read requests are successively inputted, the data processor 30 successively makes read requests for reference data to the memory controller 20, stores reference data inputted from the memory controller 20 in the cache 34, and outputs the stored reference data.

Referring to FIG. 5, the data processor 30 includes the cache 34, an internal memory address processing unit 32, an external memory address processing unit 31, a tag index processing unit 33, and a selection output unit 35. The cache 34 is configured to store and output reference data. The internal memory address processing unit 32 is configured to generate an internal memory address for outputting the reference data and output the internal memory address. The external memory address processing unit 31 is configured to make a read request to the memory controller 20 using an external memory address of the reference data and store the reference data inputted from the memory controller 20 in the cache 34. The tag index processing unit 33 is configured to generate a tag and index for cache reference and output the reference data stored in the cache 34 when a cache hit occurs. The selection output unit 35 is configured to output the internal memory address and the reference data.

For reference, the position of the reference data is transmitted together with the reference frame index and the screen position of the reference data, and the external memory address, the internal memory address, and the tag and index are generated from the position of the reference data.

The external memory address processing unit 31 includes an external memory address generation section 311, an external memory address storage section 312, a reference data input and output section 313, and a reference data storage section 314.

The external memory address generation section 311 is configured to generate an external memory address for outputting the reference data from the position of the reference data.

The external memory storage section 312 is configured to store the external memory address generated by the external memory address generation section 311. The external memory address storage section 312 first outputs a first-stored external memory address according to a first-in first-out (FIFO) method.

The reference data input and output unit 313 is configured to input the external memory address stored in the external memory address storage section 312 to the memory controller 20 and receive reference data based on the external memory address from the memory controller 20.

The reference data storage section 314 is configured to store the reference data of the external memory address. The external memory address storage section 312 first outputs first-stored reference data according to the FIFO method.

Here, the memory controller 20 receives read requests from the data processor 30 through one or more ports and controls the external memory 10 such that an overlapped read operation of the external memory 10 may be performed for the read requests for different banks which are successive or simultaneously exist. In this case, the reference data are sequentially and successively requested according to the Y direction of a block during a motion estimation or motion compensation process.

The internal memory address processing unit 32 includes an internal memory address generation section 321 and an internal memory address storage section 322.

The internal memory address generation section 321 is configured to generate an internal memory address from the position of the reference data.

The internal memory address storage section 322 is configured to store the internal memory address generated by the internal memory address generation section 321.

The tag index processing unit 33 includes a tag index generation section 331 and a tag index storage section 332.

The tag index generation section 331 is configured to generate a tag and index from the position of the reference data.

The tag index storage section 332 is configured to store the tag and index generated by the tag index generation section 331.

The selection output unit 35 is configured to selectively output an internal memory address and reference data. When a cache hit occurs, the selection output unit 35 outputs the reference data inputted from the cache 34 and the internal memory address inputted from the internal memory address generation section 321. When a cache miss occurs, the selection output unit 35 outputs the reference data inputted from the cache 34 and the internal memory address stored in the internal memory address storage section 322.

Hereinafter, referring to FIG. 6, a request process and an output process of reference data will be described.

In FIG. 6, it is assumed that eight reference pixel data are read through one external memory read command, and requests for eight pixel rows are successively made.

The assumption may differ depending on the data bus width of the memory controller 20 and the configuration and operation characteristics of the data processor 30.

Referring to FIG. 6, reference data for zero-th to seventh pixel rows are successively requested at a cache reference step 0, and the update of the cache 34 for a cache miss occurring at the cache reference step 0 is performed at a cache update step 0.

Then, reference data for eighth to 15th pixel rows are successively requested at a cache reference step 1, and the update of the cache 34 for a cache miss occurring at the cache reference step 1 is performed at a cache update step 1.

At the cache reference step, a cache hit or cache miss for each pixel row may occur. In the case of the cache hit, the data processor 30 reads an internal memory address and reference data and outputs the read internal memory address and reference data.

On the other hand, in the case of the cache miss, the data processor 30 reads an address on the external memory 10 from the position of the reference data and stores the read address. Then, the data processor 30 outputs the stored address with the internal memory address.

The external memory address generation section 311 generates an external memory address from the position of the transmitted reference data, the internal memory address generation section 321 generates an internal memory address for outputting the reference data, and the tag index generation section 331 generates a tag and index for cache reference to perform cache reference.

In this case, when a cache hit occurs, the reference data read from the cache 34 is written into the internal memory address generated by the internal memory address generation section 321. When a current pixel row is not the last pixel row at the cache reference step, cache reference based on a read request of reference data for the next pixel row is continuously performed.

Meanwhile, when a cache miss occurs, the internal memory address generated by the internal memory address generation section 321 is stored in the internal memory address storage section 322, and the tag and index generated by the tag index generation section 331 are stored in the tag index storage section 332.

At this time, the external memory address generated by the external memory address generation section 311 is transmitted to the external memory address storage section 312 and stored therein.

Meanwhile, when the current pixel row is not the last pixel row of the cache reference step, cache reference is continuously performed for a read request of reference data for the next pixel row.

The reference data input and output section 313 issues a read command to the memory controller 20, in order to read reference data existing at the external memory address stored in the external memory address storage section from the external memory 10.

In this case, one pixel row including pixels successive in the left and right direction of the reference frame is stored in one bank of the external memory 10, and the next pixel row is stored in another bank such that pixel rows adjacent in the upper and lower sides exist in different memory banks. Therefore, a read request for reference data accesses any one memory bank of the memory banks. While the reference data is outputted from the corresponding memory bank, a read request is made to the next memory bank.

Through this operation, the memory controller 20 reads the reference data from the external memory 10, and the reference data input and output section 313 stores the reference data in the reference data storage section 314.

When the cache reference step is completed, the cash update step is performed. That is, the reference data stored in the reference data storage section 314 is read to substitute for a tag and reference data corresponding to the tag and index stored in the tag index storage section 332. At this time, the reference data is outputted to the internal memory address stored in the internal memory address storage section 322.

Meanwhile, it has been described that the above-described cache update step is performed after the cache reference step is performed. The embodiment of the present invention is not limited thereto, but the cache reference step and the cache update step may be continuously performed.

That is, when a cache miss occurs at the cache reference step, the cache update is instantly performed. For example, whenever a cache miss occurs, an external memory address may be read and stored in the cache 34 to perform the cache update.

In this case, according to reference data read requests which are successively inputted, the cache reference is performed during the cache update. Therefore, the cache 34 may be implemented as a memory capable of simultaneously performing read and write operations.

Furthermore, when an external memory address is stored in the external memory address storage section 312, the reference data input and output section 313 inputs a read command to the memory controller 20, in order to read reference data stored in the external memory 10. Accordingly, the reference data storage section 314 sequentially stores the reference data stored in the external memory 10.

In accordance with the embodiment of the present invention, it is possible to significantly reduce the time required reading the reference data from the external memory. Therefore, it is possible to implement a system which is capable of compressing and decompressing a large screen size video when the same data bus width is provided, and which has a smaller data bus width when the same screen size of screens are compressed and decompressed.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A caching apparatus for video motion estimation and compensation, comprising:
an external memory comprising a plurality of banks and configured to allocate one pixel row to one bank to store the pixel row;
a memory controller configured to cause different banks of the external memory to be accessed according to successively-inputted read requests and to transmit a read command for a next read request to the external memory while reference data corresponding to a first-coming read request is outputted; and
a data processor configured to successively make read requests for the reference data to the memory controller when reference data read requests are successively inputted, store the reference data inputted from the memory controller, and output the stored reference data.

2. The caching apparatus of claim 1, wherein an external memory address of the reference data stored in the external memory is generated in such a manner that the least significant bit of a Y position value of the reference data is allocated to a bank value of the external memory address.

3. The caching apparatus of claim 1, wherein the data processor comprises:
a cache configured to store and output the reference data;
an internal memory address processing unit configured to generate an internal memory address for outputting the reference data and output the generated internal memory address;
an external memory address processing unit configured to generate an external memory address of the reference data to make a read request to the memory controller through the external memory address, and store the reference data inputted from the memory controller in the cache; and
a tag index processing unit configured to generate a tag and index for cache reference and output the reference data stored in the cache when a cache hit occurs,
wherein, at a cache reference step, when a cache hit occurs, the internal memory address and the tag and index are outputted, and
at a cache update step, the reference data and the internal memory address are outputted according to a cache miss occurring at the cache reference step.

4. The caching apparatus of claim 3, wherein the cache update step is performed after the cache reference step according to successive read requests is completely performed.

5. The caching apparatus of claim 3, wherein when a cache miss occurs during the cache reference step according to successive read requests, the cache update step is performed immediately after the cache miss.

6. The caching apparatus of claim 1, wherein the external memory address processing unit comprises:
an external memory address generation section configured to generate an external memory address of the reference data for outputting the reference data;
an external memory address storage section configured to store the external memory address generated by the external memory address generation section;
a reference data input and output section configured to read the external memory address stored in the external memory address storage section and request the memory controller to read the reference data stored in the external memory; and
a reference data storage section configured to store the reference data inputted from the reference data input and output section and then store the reference data in the cache.

7. The caching apparatus of claim 1, wherein the internal memory address processing unit comprises:
an internal memory address generation section configured to generate an internal memory address from an address of the reference data; and
an internal memory address storage section configured to store the internal memory address generated by the internal memory address generation section when a cache miss occurs.

8. The caching apparatus of claim 1, wherein the tag and index processing unit comprises:
a tag index generation section configured to generate the tag and index from an address of the reference data; and
a tag index storage section configured to store the tag and index generated by the tag index generation section when a cache miss occurs.

9. A caching method for video motion estimation and compensation, comprising:
allocating one pixel row of a reference frame to one bank to store the pixel row; and
when read requests are successively inputted due to a cache miss, accessing different banks of the external memory, and transmitting a read command for a next read request to the external memory while reference data corresponding to a first-coming read request is read and outputted.

10. The caching method of claim 9, wherein the external memory address of the reference data is generated in such a manner that the least significant bit of a Y position value of the reference data is allocated to a bank value of the external memory address.

11. A caching method for video motion estimation and compensation, comprising:
allocating one pixel row of a reference frame to one bank to store the pixel row;
performing a cache reference step as reference data are successively requested; and
when a cache miss occurs during the cache reference step, reading the reference data by accessing different banks of an external memory according to the read requests of the reference data and performing a cache update step.

12. The caching method of claim 11, wherein the performing of the cache update step comprises transmitting a read command for a next read request to the external memory while the reference data is read from the external memory and outputted.

13. The caching method of claim 11, wherein the cache update step is performed after the cache reference step is completely performed.

14. The caching method of claim 11, wherein the cache update step is performed immediately after the cache miss occurs while the cache reference step is performed.

15. The caching method of claim 11, wherein an external memory address of the reference data is generated in such a manner that the least significant bit of a Y position value of the reference data is allocated to a bank value of the external memory address.
